(19) United States
(12) Patent Application Publication
(10) Pub. No.: US 2019/0227521 A1
(43) Pub. Date: Jul. 25, 2019

(54) METHOD FOR MONITORING AT LEAST ONE MACHINE TOOL AND PRODUCTION SYSTEM

(71) Applicant: KOMET Deutschland GmbH, Besigheim (DE)

(72) Inventor: Jan-Wilm BRINKHAUS, Isernhagen (DE)

(21) Appl. No.: 16/330,513

(22) PCT Filed: Sep. 11, 2017
(86) PCT No.: PCT/EP2017/072743

§ 371 Date: Mar. 5, 2019

(30) Foreign Application Priority Data
Sep. 12, 2016 (DE) 10 2016 117 101.8

(51) Int. Cl. G05B 19/406; G05B 19/401

(52) U.S. Cl. CPC G05B 19/406; G05B 2219/37344; G05B 2219/37526; G05B 19/401

(57) ABSTRACT

A method for monitoring at least one machine tool (12) featuring the steps (a) real-time detection of time-dependent measurement data (Mᵢ) characterising a production process running on the machine tool (12), (b) provision of the measurement data (Mᵢ) with a time stamp which encodes a time (tⱼ) at which a respective measurement data (Mi) was detected, such that measurement results (Mᵢ(tⱼ)) are obtained, (c) transmission of the measurement results (Mᵢ(tⱼ)) via a non-real-time-capable data bus (26) to an evaluation unit (28), (d) calculation of at least one command (B) from the measurement results by means of the evaluation unit, (e) transmission of the at least one command (B) via the data bus (26) and (f) monitoring of the production process in real-time by means of a programme that contains the command (B).

The invention relates to a method for monitoring at least one machine tool. According to a second aspect, the invention relates to a production system.

The monitoring of machine tools is common practice. Monitoring may serve to reduce production time. To this end, a machine controller or an independent machine tool monitoring device may be programmed in such a way that it continuously adjusts the optimal processing speed of a production programme on the basis of recorded measurement data. The monitoring of machine tools for potential tool breakage or an overload of the machine tool, for instance due to a tool having been incorrectly exchanged, is also common practice.

This type of monitoring process is conducted in real-time so as to enable timely intervention. This means that the machine tool monitoring device communicates with sensors or the machine controller of the machine tool such that a pre-set maximum reaction time is not exceeded during communication.

The disadvantage of known machine monitoring devices is the considerable effort required for maintenance and installation.

DE 10 2009 024 101 A1 describes a monitoring system for a machine tool which saves data collected in real-time in an action memory. A data processing system accesses this action memory; this data processing system determines the condition of the machine tool using the data. This renders it possible to recognise accidents and limit their impact by way of early maintenance. The disadvantage of such a system is that the productivity of the machine tool can only be increased indirectly.

D2 DE 10 2007 048 961 A1 describes a method for processing a workpiece during which forces on the machining head are recorded and analysed in real-time. The results of the analysis are used to adjust the regulation of the processing procedure. This type of system is described in the introduction of the patent application and requires that the machine tool itself has considerable computational capacity.

DE 101 52 765 A1 describes that a machine tool sends data collected in real-time to a central computer, which evaluates this data and generates machine-related data or services. For instance, limits of process variables are monitored and assessed. This means that the data from a ballbar test can be used to determine the processing accuracy of the machine tool on the central computer. If necessary, the process is stopped.

EP 2 793 088 A1 instructs that the process parameters of a machine tool are to be measured and a difference to a target signal stored. This difference can be evaluated on an external computer. This allows for remote maintenance of the machine tool.

The invention aims to reduce disadvantages of the prior art.

The invention solves the problem by means of a method with the features described in claim 1.

According to a second aspect, the invention solves the problem by means of a production system with (i) a first machine tool, which comprises a first non-real-time-capable machine controller, (ii) at least a second machine tool, which comprises a second non-real-time-capable machine controller, and (iii) an evaluation unit, (iv) a non-real-time-capable data bus, which connects the first machine tool and the at least one second machine tool to the evaluation unit, wherein (v) the machine tools are setup to automatically (a) detect time-dependent measurement data characterising a production process running on the machine tool, (b) provide the measurement data with a time stamp, which encodes a time at which respective measurement data was detected, such that measurement results are obtained, and (c) transmit the measurement results via the data bus to the evaluation unit, wherein (vi) the evaluation unit is configured to automatically (a) calculate at least one command for the machine tools from the respective measurement results and (b) transmit the at least one command via the data bus to the machine tools and wherein (ii) the machine tools are configured to automatically (a) receive the at least one command from the evaluation unit, and (b) monitor the production process by means of a programme that contains the command. The machine tools are preferably configured to automatically (c) determine a reaction time of the data bus and (d) limit a processing speed value to a maximum processing speed value if the reaction time exceeds a pre-set reaction time threshold value.

The advantage of the invention is that the hardware requirement of the machine tool is smaller. Given that the evaluation is not conducted centrally, the machine tools need only be capable of detecting measurement data, providing it with a time stamp and executing the monitoring programme.

It is especially advantageous that an adjustment to the programme used for evaluation must only be implemented on one computer, namely the evaluation unit. For instance, if the production speed has to be increased, this is easily done by adjusting the corresponding monitoring programme in such a way that the processing speed of all production programmes is centrally increased. Although this does cause an increase in tool wear, this aspect can be deemed less significant. On the other hand, if the capacity utilisation of the plant is low, the production speed for all or several machine tools can quickly be lowered to reduce tool wear and thereby save on production costs.

It is beneficial that two or more machine tools can be monitored without requiring a real-time-capable bus system. The invention is based on the knowledge that it is preferable but not necessary to process the measurement data in real-time, as long as there is a guarantee that the programme running on the machine tool monitoring device is designed such that, in the absence of commands generated in real-time, the machine tool monitoring device does not intervene in the pre-set programme, or only does so to the extent that production errors are largely ruled out. Even with non-real-time-capable data buses it can also be assumed that a maximum delay time between the time at which a command would arrive via a real-time-capable data bus and the time at which the command actually arrives via the non-real-time-capable data bus is sufficiently short so as to largely rule out compromising the machine tool.

Within the scope of the present description, a real-time-capable device should be understood to mean a device that is constructed in such a way that pre-set results are guaranteed to be achieved within a pre-determined time period, namely the reaction time. In particular, the machine controller is designed to monitor the ma- chine tool in real-time in accordance with DIN 44300. In particular, a reaction time has a value of at most one interpolar cycle, at most one position controller cycle and/or at most one PLC cycle of the respective machine tool. A reaction time is preferably a maximum of 50 milliseconds, especially 10 milliseconds.

A machine tool should be understood especially to mean a cutting or mental forming machine tool.

The principle of providing the measurement data with a time stamp should be understood particularly to mean that the time at which the measurement data was either recorded or at which the machine was in the condition described by the measurement data is allocated to the individual measurement data or a group of measurement data. It is possible that the measurement data refers to reduced data, for example a moving average across a pre-set averaging period, which has a maximum length of 10 milliseconds, for example. The time may refer to the real time. Alternatively, it is possible for the stated time to be a machining time.

The feature that the measurement results are transmitted via a non-real-time-capable data bus should be understood particularly to mean that at the time when the measurement results are transmitted, the data bus is not operating in real-time mode. It is thus theoretically conceivable that the data bus can generally be operated in real-time, but that the measurement results are non real-time-capable and/or are not transmitted in real-time. In other words, it cannot be guaranteed that a pre-set reaction time, as described above, is maintained. In particular, the data bus is not real-time-capable as a result of its construction. The data bus is preferably constructed in such a way that, as a result of its construction, a reaction time that is smaller than a maximum of 100 ms is not guaranteed.

The command should be be understood particularly to mean an instruction for the machine tool or the machine controller. This command is an instruction in the sense that it determines how the machine tool is monitored. It is irrelevant how this command is encoded.

It is possible but not necessary for the command to be formed of a parameter or a set of parameters which, in combination with a pre-formulated raw command of the machine tool monitoring device stored in the machine controller and/or in a machine tool monitoring device, if present, is extended to become a complete command. For example, this sort of parameter may refer to the P, PI or PID controller and/or a threshold value which, when exceeded, leads to a reduction in the override value of the machine tool. The override value, which may also be referred to as the processing speed value, defines the speed at which a production programme should be executed. Generally speaking, the override value is given as a percentage of a base processing speed which corresponds to 100%.

The detection of the measurement data may comprise a reading of the machine controller. Alternatively or additionally, the detection of the measurement data may comprise a capture of sensor data from at least one sensor, which is not connected to the machine controller. This sensor may refer, for instance, to an acceleration sensor which, for example, is arranged on a tool of the machine tool or a tool housing device of the machine tool and measures acceleration, especially linear acceleration, of the tool.

According to a preferred embodiment, the detection of the time-dependent measurement data and the provision of the measurement data with a time stamp occurs by means of a machine controller, in particular an NC controller or a PLC controller. The machine controller controls and/or regulates the positioning of the tool. It is preferable if at least one production programme, which contains the instructions by means of which the components of the machine tool are moved, runs on the machine controller in order to produce the workpiece, as well as one monitoring programme. The monitoring programme contains commands for monitoring the production process. An example is contained in DE 10 2009 025 167. The monitoring programme and the production programme run simultaneously, preferably on the same processor.

The measurement results are preferably transmitted to the evaluation unit by a machine tool monitoring device, especially an operating panel computer or a central server. A machine tool monitoring device is a computing device that is independent of the machine controller and which is connected to the machine controller for communication purposes. An operating panel computer is a computer by means of which a graphic user interface is generated on a screen. Operating panel computers are provided on most machine tools.

The command is preferably a condition command, i.e. a command which renders an action to be conducted dependent on a condition. For instance, the command refers to a set of parameters of at least two parameters, wherein one parameter gives a threshold value: if this threshold value is exceeded or not reached, the override value should be reduced or raised. The other parameter indicates the extent to which the override value should be amended depending on a deviation from the threshold amount. For example, the first parameter indicates a target motor torque M_{Soll} or a value which describes this torque, such as an armature current of the motor. If this target motor torque is exceeded by x %, the override value reduces by ax % points, especially to 100%-ax %.

In this case, the parameter M_{Soll} and the gain factor a form a set of parameters which represent the command. The machine controller or the machine tool monitoring device, if present, inserts these parameters into the raw command, which states that the actual motor torque M_{Ist} is detected, compared with the target motor torque M_{Soll} and that an upward deviation of the actual motor torque leads to a reduction in the override value as stated above.

The command then encodes when or to what extent the processing speed value is to be amended, wherein the processing speed value encodes a speed with which a production programme is executed on the machine tool.

The monitoring of the production process preferably comprises a monitoring for tool breakage and/or tool wear.

A preferred method comprises the steps: identification of a reaction time of the data bus, especially by means of the machine tool monitoring device, and a limiting of the processing speed value to a maximum processing speed value if the reaction time exceeds a pre-set reaction time threshold value. The processing speed value will otherwise not be limited. The reaction time is identified, for example, by the machine tool monitoring device transmitting a response request (ping command) to the evaluation unit, which answers this request as quickly as possible. The reaction time is then half the time that passes between the transmission of the response request and the receipt of the answer.

According to a preferred embodiment, the programme that contains the transmitted command is used for monitoring the production process during which the measurement data was detected from which the command was calculated. In other words, a short-term feedback effect occurs between the measurement data captured and the at least one command calculated from this data, i.e. during the production process. Thus far, this sort of short-term response has only been achieved with real-time systems as it was the only way to ensure that commands are not received too late. The invention is based on the knowledge that such a delay may be tolerable, especially if it is guaranteed that the only negative consequences a delay can have is that productivity is not as high as it could be if there were no delay.

In order to achieve a short reaction time, a processing time between the detection of measurement data and the receipt of the command transmitted by the data bus, wherein this command was calculated using the measurement data, is a maximum of 60 seconds, in particular a maximum of 10 seconds. Of course, this time is exceeded if the data bus fails. However, in this case it is crucial that the processing time during smooth operation is maintained in 95% of cases, for example.

A maximum response time between the transmission of the measurement results to the evaluation unit and a receipt of the command transmitted by the data bus is preferably 30 seconds, especially a maximum of 10 seconds.

A maximum response time between the transmission of the measurement results to the evaluation unit and a receipt of the command transmitted by the data bus is preferably 1 second. In other words, the transmission occurs quickly, if not necessarily in real-time.

The command is preferably a condition command and encodes that a processing speed is reduced, especially to zero (so the production process stops), if a process parameter, which describes a process force, exceeds a process parameter maximum value encoded in the command. For example, if a force is acting on a machine axis, of which the machine tool preferably has at least two, wherein this force represents a process parameter and is greater than the process parameter maximum value, the processing speed is reduced until the process parameter maximum value is no longer exceeded.

The command is preferably a condition command and encodes that the production process stops if a spindle parameter, which describes a spindle torque of a spindle of the machine tool, exceeds a maximum value encoded in the command. The monitoring of the production process preferably comprises the step of reading the measurement data from a machine controller of the tool machine. If the spindle parameter exceeds the maximum value, a command is sent to the machine controller communicating that a processing speed of the production programme shall be reduced until the maximum value is no longer exceeded. The evaluation unit and the machine controller are thus part of a control loop for regulating the spindle parameter until it reaches a value below the maximum value.

The reduction of the processing speed may also comprise stopping the production programme and thereby stopping the production process. This prevents the tool from being overloaded. In particular, the reduction of the processing speed may accompany a display of a corresponding notification on a machine operating panel.

For instance, the spindle parameter may be an armature current in the spindle, a power consumption of the spindle or the spindle torque itself.

The command is preferably a condition command and encodes that the production process stops if the spindle parameter does not reach a minimum value encoded in a command for a pre-set time period. The command may encode the time period or the time period may be pre-set and, for example, stored in the machine tool monitoring device. If the minimum value is not reached for the pre-set period of time, it is an indication that a tool which is used for production is broken.

The production system is preferably configured to conduct a method that features the above-stated steps.

The method preferably comprises a visualisation of the measurement data by means of the evaluation unit.

In the following, the invention will be explained in more detail by way of the attached drawings. They show

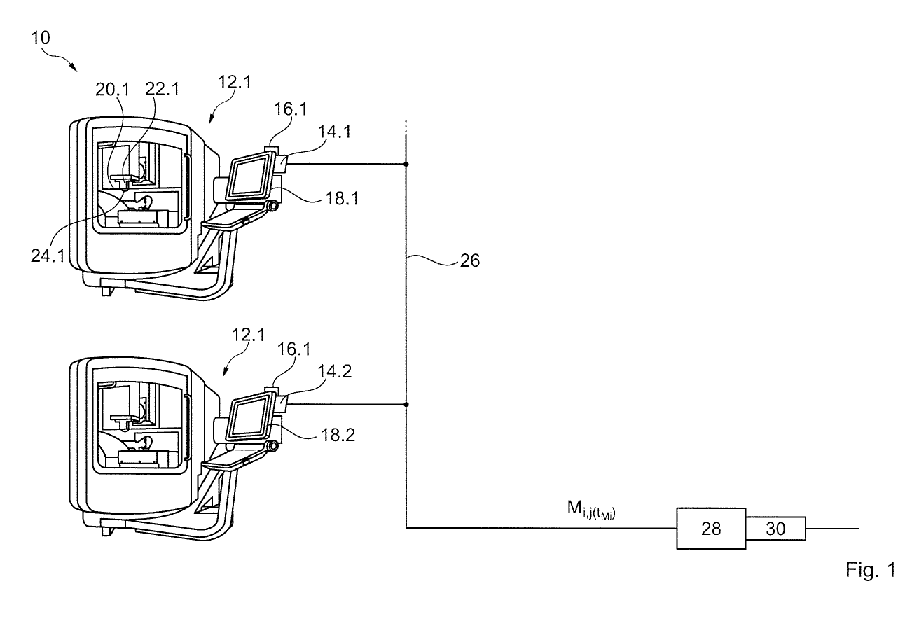

FIG. 1 a schematic view of a production system according to the invention for conducting a method according to the invention and

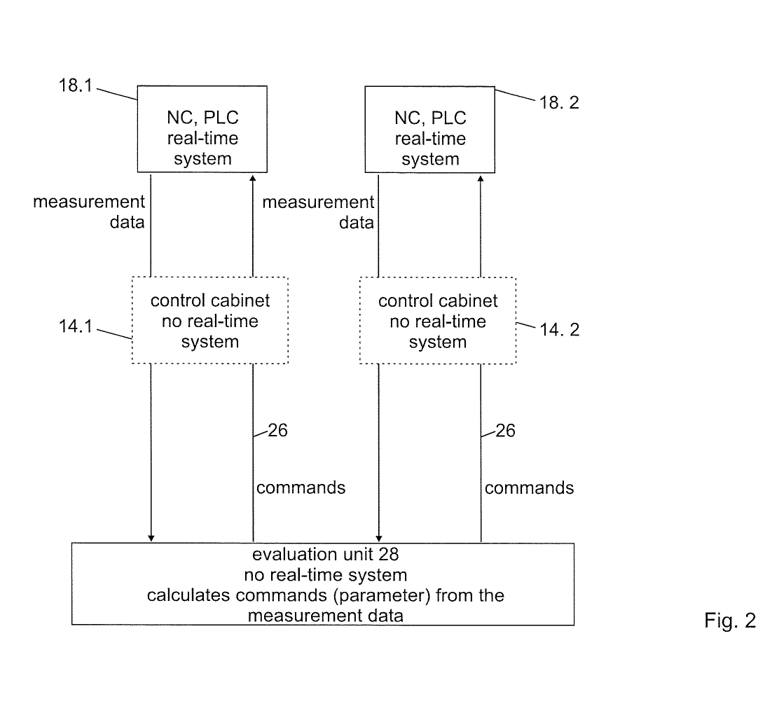

FIG. 2 a diagram depicting the operational sequence of a method according to the invention,

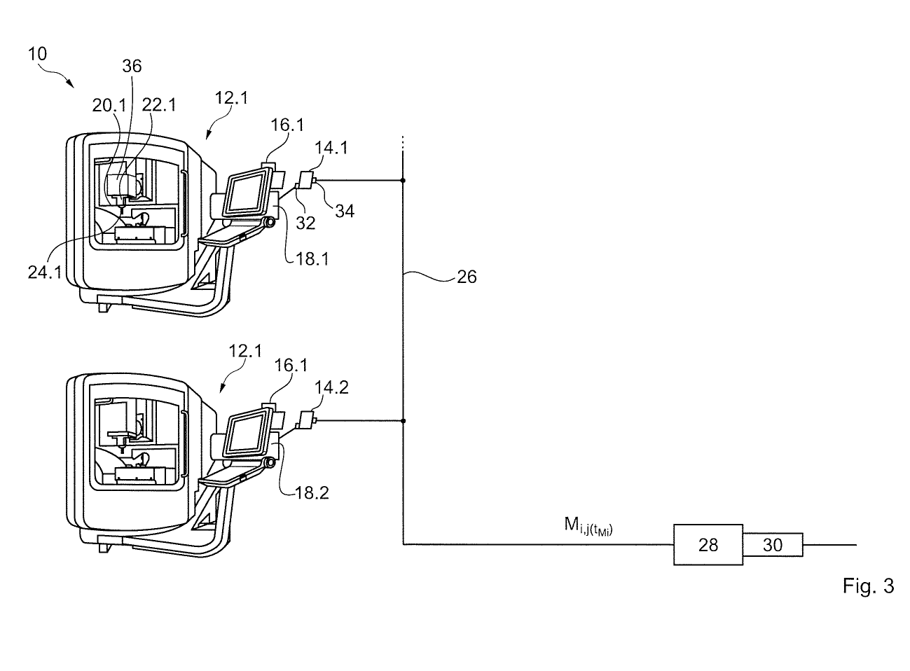

FIG. 3 a schematic view of a second embodiment of a production system according to the invention for conducting a method according to the invention.

FIG. 1 shows a production system 10 according to the invention with a first machine tool 12.1 and at least a second machine tool 12.2 as well as a first machine tool monitoring device 14.1 in the form of a first operating panel computer and a second machine tool monitoring device 14.2 in the form of a second operating panel computer. The two machine tool monitoring devices 14 are connected to a respective machine controller 18.1 or 18.2 via respective data connections 16.1, 16.2, for instance by means of cables and/or plug connections.

The machine controller 18.i (i=1, . . . N; N: number of machine tools in the production system) controls the respective machine tool 12.i such that it executes a pre-set production programme. The operating panel computers 14.i are not real-time-capable. In particular, an editor for a production programme runs on these computers. Upon provision of the production programme it is transmitted to the respective machine controller 18.1 or 18.2 and carried out in real-time.

The machine controllers 18.i record measurement data at regular intervals tⱼ and combine these with a time stamp, thereby producing measurement results Mⱼ(tⱼ) (j=1, 2, . . . ). The machine tool monitoring devices 14.i communicate with the respective machine controllers 18.i in such a way that they read measurement results Mⱼ(tⱼ) (j=1, 2, . . . ) from the machine controller 18.9 at regular intervals tⱼ. The measurement values Mⱼ may refer to outputs Lₛ of one or several drive motors, the torques M_{A,j} produced by the motors or the correlating values, such as the armature currents Iⱼ.

The first machine tool 12.1 preferably has at least one sensor 20.1, such as an acceleration sensor, which is arranged on a tool housing 22.1. In the present illustrative case, the machine tool 12.1 refers to a milling machine and a cutter 24.1 is fixed to the tool housing 22.1.

To ensure that all machine tools 12.i have the same machining time, it is advantageous if the machine tool monitoring devices 14.i detect a network time at regular intervals, this network time being transmitted by the data bus 26 for example, and transmit the network time to the machine controllers 18.i. However, it is also possible that the machining times of the machine tools 12.i vary from one another. Alternatively—although technically more complex—the machine tool monitoring device 14 has a clock that measures the absolute time t_{a,j}.

The machine tool monitoring devices 14.i are connected to an evaluation unit 28 by means of a data bus 26. A distance between the evaluation unit 28 and the machine tools 12.i is preferably at least 10 metres, in particular the evaluation unit 28 is arranged in a different control cabinet to the controller(s) of the machine tools 12.1. It is possible and represents a preferred embodiment that the evaluation unit 28 is connected to the internet via an interface 30. In other words, the evaluation unit 28 is configured to communicate in an HTML or XML format.

The evaluation unit 28 detects the measurement data M_{i,j}=M_{i,j}(t_{Mi,j}), which are provided with the respective time stamps t_{Mi,j}, namely the respective j-th machining time Mᵢ of the i-th machine tool.

For each machine tool 12.i, an individual evaluation of the measurement data M_{i,j} runs on the evaluation unit 28; in particular, an individual programme runs which evaluates the measurement data M_{i,j}. In particular, the evaluation unit 28 is designed to calculate threshold values M_{S} or target values M_{Soll} for the recorded measurement data M. For instance, if a drive torque M_{A} of a feed axis is detected, a threshold value M_{S} in the form of a threshold drive torque M_{S,Arm} is calculated. This threshold value M_{S} is then sent back to the machine tool monitoring device 14.1 via the data bus 26.

The threshold value M_{S} refers to a parameter which is completed with a pre-set raw command in the machine tool monitoring device 14.1 or the machine controller 18.1 to become the command which triggers an action when this threshold value M_{S} is exceeded. For example, an override value A, which may also be referred to as a processing speed value, is reduced by ax % points if the threshold value M_{S} is exceeded by x %. The parameter a is a gain factor.

Alternatively or additionally, the evaluation unit 28 calculates a target value, such as a target motor torque M_{Soll} and the gain factor a. The machine tool monitoring device 14 or the machine controller 18 enters the two parameters in the monitoring programme and calculates the value for the processing speed as A=100%+a(M_{S}−Mⱼ(t))/M_{S}.

The machine tool monitoring device 14 sends a test message at regular intervals, for instance once per second, to the evaluation unit 28; the evaluation unit 28 then sends control information back to it. The machine tool monitoring device 14.1 then identifies a reaction time τ and if the reaction time τ is above a pre-set threshold value τₛ once or several times, the machine tool monitoring device 14 reduces the processing speed value A to a pre-set maximum processing speed value Aₘₐₓ, for example to 100%. In other words, it is then possible that this processing speed value A is smaller than Aₘₐₓ, but it cannot exceed Aₘₐₓ. This ensures that the machine tool monitoring device 14.1 does not bring the machine tool into a state which could compromise it.

According to a preferred embodiment, the machine controller 18.i is programmed in such a way that if the threshold value τₛ is exceeded, the production programme is run in a safety mode. It is possible for an operator to set and/or determine an override value in this safety mode such that the execution of the current monitoring programme continues. Alternatively or additionally, the machine tool can be shut down, meaning that production is interrupted.

FIG. 2 schematically shows that the evaluation unit 28 is not connected to the machine controller 18.i via the data bus 26 that is not real-time-capable or not operated in real-time. Of course, it is possible for all or only one part of the machine tools 12 of a production system 10 to be connected to the evaluation unit 28. The machine tool monitoring devices 14.i are dispensable if the respective machine controller 18.i comprises a data bus interface. The evaluation unit 28 is preferably physically separate from the machine controllers 18.i

The data bus 26 may be, for example, a fieldbus in accordance with IEC 61158 or a non-real-time-capable ethernet bus.

FIG. 3 schematically depicts a machine tool monitoring device 14 according to the invention which is designed to be separate from the operating panel computer and with a first interface 32 that is connected to the machine controller 18. The machine toll monitoring device 14 reads the measurement data M from the machine controller 18 via the first interface 32, provides them with a time stamp and continuously sends them to the evaluation unit 28.

The machine tool monitoring device 14 also has a second interface 34, by means of which it is connected to the evaluation unit 28. A monitoring programme runs on the machine tool monitoring device 14 that is capable of giving commands to the machine controller 18. Commands from the evaluation unit 28 are entered into the monitoring programme and executed. For instance, the evaluation unit 28 continuously calculates a maximum value and a minimum value for a spindle parameter in the form of a spindle torque which acts on a spindle 36. If the measurement value M identified exceeds the maximum value, the machine tool monitoring device 14 controls the machine controller in such a way that it decreases the processing speed at which the production programme is conducted. The spindle torque reduces as a result. The reduction in the processing speed may go down to zero, thereby stopping the processing.

It is also possible but not necessary for the command, which is sent by the evaluation unit 28, to encode a maximum force that acts on one of the machine axis of the machine tool 12. This may be determined by way of the armature current of the drive motor, for instance.

As shown in FIG. 3, since the production system 10 may comprise two or more machine tools 12 but only requires one evaluation unit 28, the capital expenditure required to monitor the machine tools decreases.

### REFERENCE LIST

10 production system
12 machine tool
14 machine tool monitoring device, operating panel computer
16 data connection
18 machine controller
20 sensor
22 tool housing
24 cutter
26 data bus
28 evaluation unit
30 interface
32 first interface
34 second interface
36 spindle
A processing speed value (=override value)
a gain factor
i running index (machine tool number)
j running index (time number)
M measurement data
M_{A} drive torque
M_{S} threshold value
N number of machine tools
t_{M} machining time
tₐ absolute time
τ reaction time

1. A method for monitoring at least one machine tool, comprising:
(a) detecting in real-time time-dependent measurement data characterizing a production process running on the machine tool,
(b) providing the time-dependent measurement data with a time stamp which encodes a time at which a respective measurement data was detected,
(c) transmitting the time stamped. time-dependent measurement data as measurement results by a non-real-time-capable data bus to an evaluation unit,
(d) calculating, using the evaluation unit, at least one command from the measurement results,
(e) transmitting the at least one command via the data bus to a machine controller; and
(f) monitoring or adjusting the production process in real-time by executing a program on said machine controller that implements the at least one command.

2. The method according to claim 1, further comprising:
determining a reaction time of the data bus, and
if the reaction time exceeds a pre-set reaction time threshold value, limiting a processing speed value that encodes a speed at which the program is executed on the machine tool to a maximum processing speed value.

3. The method according to claim 1 wherein the program that implements the at least one command is used for monitoring the production process during which the measurement data was detected and from which the at least one command was calculated.

4. The method according to claim 1 wherein a maximum response time between transmission of the measurement results to the evaluation unit and a receipt of the at last one command transmitted via the data bus is no more than 1 second.

5. The method according to claim 1 wherein a processing time between detecting the measurement data and receipt of the at least one command transmitted via the data bus, wherein this at least one command was calculated using the measurement data, is a maximum of 60 seconds.

6. The method according to claim I wherein the at least one command is a condition command which encodes when and/or to what extent a processing speed value is to be adjusted, wherein the processing speed value encodes a speed at which a machine tool is operated, and wherein the at least one command encodes at least one parameter which describes a dependency of one adjustment of the processing speed value of a machine parameter.

7. The method according to claim 1 wherein the at least one command is a condition command and encodes production process stops if a process parameter, which describes a process force, exceeds a process parameter maximum value encoded in the at least one command.

8. The method according to claim 1 wherein the at least one command is a condition command and encodes production process stops if a spindle parameter, which describes a spindle torque of a spindle of the machine tool, exceeds a maximum value encoded in the command.

9. The method according to claim 1 wherein the at least one command is a condition command and encodes production process stops if the spindle parameter does not reach a minimum value encoded in the command for a pre-determined period.

10. The method according to claim 1, wherein
at least two machine tool monitoring devices are connected to the evaluation unit via the data bus,
wherein each machine tool monitoring device detects time-dependent measurement data of a machine tool, and
wherein the evaluation unit calculates commands for each of the at least two machine tool monitoring devices from the respective measurement results (Mᵢ(tⱼ)).

11. A production system, comprising:
(i) a first machine tool
which comprises a first real-time-capable machine controller,
(ii) at least a second machine tool
which comprises a second real-time-capable machine controller,
(iii) an evaluation unit,
(iv) a non-real-time-capable data bus which connects the first machine tool and the at least one second machine tool to the evaluation unit,
(v) wherein the first machine tool and the at least a second machine tool are installed to automatically
(a) detect time-dependent measurement data characterizing a production process,
(b) provide the measurement data with a time stamp which encodes a time at which a respective measurement data was detected, such that measurement results are obtained, and
(c) transmit the measurement results via the data bus to the evaluation unit,
(vi) wherein the evaluation unit is configured to automatically
(a) calculate at least one command for one or more of the first machine tool and the at least a second machine tool from the respective measurement results and
(b) transmit the at least one command via the data bus to one or more of the first machine tool and the at least a second machine tool,
(vii) wherein the first machine tool and the at least a second machine tool are configured to automatically
(a) receive the at least one command from the evaluation unit,
(b) monitor the production process using a program that contains the at least one command, and
(viii) wherein the first machine tool and the at least one second machine tool are configured to automatically
(c) determine a reaction time of the data bus, and
(d) if the reaction time (τ) exceeds a pre-set reaction time threshold value (τ_{S}), limit a processing speed value to a maximum processing speed value.

12. The production device according to claim 11, further comprising
(i) a first non-real-time-capable machine tool monitoring device that is connected to a first machine controller (18.1),
a second non-real-time-capable machine tool monitoring device that is connected to a second machine controller (18.2),
(iii) wherein the first and second non-real-time-capable machine tool monitoring devices are each is configured to automatically
(a) detect measurement results from measurement data and time stamps from the first machine controller,
(b) transmit the measurement results to the evaluation unit,
(c) receive the at least one command from the evaluation unit, and
(d) transmit the at least one command to the machine controller.

13. The production system according to claim 11 wherein
(i) the first machine controller is configured to automatically
(a) identify measurement results from measurement data and time stamps,
(b) transmit the measurement results to the evaluation unit,
(c) receive the at least one command from the evaluation unit, and
(d) monitor the production process of a first machine tool using a program which executes the at least one command, and/or
(ii) the first machine controller is configured to automatically
(a) identify measurement results from measurement data and time stamps,
(b) transmit the measurement results to the evaluation unit,
(c) receive the at least one second command from the evaluation unit, and
(d) monitor the production process of the at least a second machine tool using a program which executes the second command.

14. A machine tool monitoring device, comprising:
(a) a first interface for connecting to a real-time-capable machine controller of a machine tool,
(b) a second interface for a non-real-time-capable data bus for connecting to an evaluation unit,
(c) wherein the machine tool monitoring device is configured to automatically execute the following steps:
(i) detection of time-dependent measurement data from the machine controller, the measurement data characterising a production process running on the machine tool,
(ii) provision of the measurement data with a time stamp which encodes a time at which a respective measurement data was detected, such that measurement results are obtained, and
(iii) transmission of the measurement results via the data bus to the evaluation unit,
(iv) receipt of the at least one command from the evaluation unit,
(v) monitoring of the production process using a program that contains the at least one command,
(vi) determination of a reaction time of the data bus, and
(vii) if the reaction time exceeds a pre-set reaction threshold value,
limitation of a processing speed value to a maximum processing speed value.

15. The method of claim 6 wherein the at least one parameter is or includes machine torque.

16. The method of claim 10 wherein the at least two machine tool monitoring devices includes at least four machine tool monitoring devices.
